(19) United States
(12) Patent Application Publication
(10) Pub. No.: US 2006/0227549 A1
(43) Pub. Date: Oct. 12, 2006

(54) Christmas light arrangement

(76) Inventor: Ken Cheng, Hong Kong (HK)

Correspondence Address: CHARLES C.H. WU, 98 DISCOVERY, IRVINE, CA, 92618-3105, US

(21) Appl. No.: 11/095,157

(22) Filed: Mar. 31, 2005

(51) Int. Cl. F21V 21/00

(52) U.S. Cl. 362/249; 362/252

(57) ABSTRACT

A lighting device is provided, which includes a plurality of light strings each having at least one bi-directional electric connector electrically connected thereto, with a single bi-directional electric connector connect to a power source, and the rest of the bi-directional electric connectors electrically coupled to the power source having the single bi-directional electric connector interposed therebetween.

### BACKGROUND OF THE INVENTION

1. Field of the Invention

The invention pertains to the field of lighting arrangements. More particularly, the invention pertains to Christmas lighting arrangements.

2. Description of Related Art

Christmas lighting related decorations are widely known. The known lightings necessarily use connectors for connecting strings at least to a power source.

United States Patent by Chen, et al. Numbered U.S. Pat. No. 5,094,632 disclosed a connector for Christmas light strings includes a wire-holding portion for receiving and holding two conducting wires and a socket-engaging portion for engaging with a conventional socket. The wire-holding portion includes two half casings each having two slots separated by a wall formed therebetween. The two half casing are formed together at one edge thereof such that the two half casings are pivotable with respect to each other. The socket-engaging portion includes an annular hollow receiving portion, a first annular protrusion, and a second annular protrusion. The annular hollow receiving portion has a compartment for receiving the wire-receiving portion.

United States Patent by Schmidt Numbered U.S. Pat. No. 5,816,849 disclosed a new Adjustable Christmas Light System for providing a lighting system which allows the user to adjustably determine the length for a specific situation and for providing a plurality of sections which may be removed upon malfunctioning. The inventive device includes a length of wire strand forming a section, at least one light connected in series within the wire strand, a female connector electrically connected at one end of the wire strand, and a male connector electrically connected to the wire strand opposite of the female connector where the female connector electrically receives a male connector from another section.

United States Patent by Cummings Numbered U.S. Pat. No. 6,042,418 disclosed a new and improved Christmas light extension cord system for extending the configurational capabilities of Christmas lights. The system includes a first wire assembly with an electrical receptacle at one end and an electrical plug at the other end and with a plurality of wires for conveying electrical current therebetween. The system is also provided with a plurality of secondary wire assemblies, each having an input end electrically coupled to the primary wire assembly and an output end terminating in a female receptacle. A plurality of third wire assemblies, each having an input end with a male connector connected to a female receptacle of the second wire assembly and an output end terminating in a light with the length of each third wire assembly being several times longer than the male connector.

United States Patent by William E. Adams Numbered U.S. Pat. No. 6,361,187 disclosed a Christmas tree outdoor ornament that has an elongated hook member with one end having a spiral hook and the other end having a hook sized to receive at least one string of decorative lights. A star fits over the body of the hook member. The spiral hook attached to a gutter or a suction cup and decorative light strings are routed from the hook member to anchors creating a triangular tree shape. The anchors may be stakes in the ground or suction cups attached to any flat surface such as a window or window sill.

However, when a user desires to have a lot strings for a single design, the amount of wire needed for connections only may greatly increase. Therefore, it is desirous to divide the lighting device into various sub-units and added on the units as more light strings are needed.

### SUMMARY OF THE INVENTION

A lighting device comprising a head ornament and a plurality of a light strings is provided. The head ornament and the plurality of a light strings are electrically coupled together via a plurality of electric connectors.

A lighting device comprising a plurality of bi-directional electric connecters connecting various units is provided. Thereby the length or amounts of electric wire needed is reduced.

A lighting device is provided, which includes a plurality of light strings each having at least one bi-directional electric connector electrically connected thereto, with a single bi-directional electric connector connect to a power source, and the rest of the bi-directional electric connectors electrically coupled to the power source having the single bi-directional electric connector interposed therebetween.

A method of producing a lighting device is provided, which includes the steps of providing a plurality of light strings each having at least one bi-directional electric connector electrically connected thereto, with a single bi-directional electric connector connect to a power source, and the rest of the bi-directional electric connectors electrically coupled to the power source having the single bi-directional electric connector interposed therebetween.

### BRIEF DESCRIPTION OF THE DRAWING

FIG. 1 shows a lighting device of The present invention.

FIG. 2a shows a light string in a first embodiment of the present invention.

FIG. 2b shows a light string in a first embodiment of the present invention.

FIG. 3 shows a bi-directional electric connector of the present invention.

FIG. 4 shows a mounting head of the present invention.

### DETAILED DESCRIPTION OF THE INVENTION

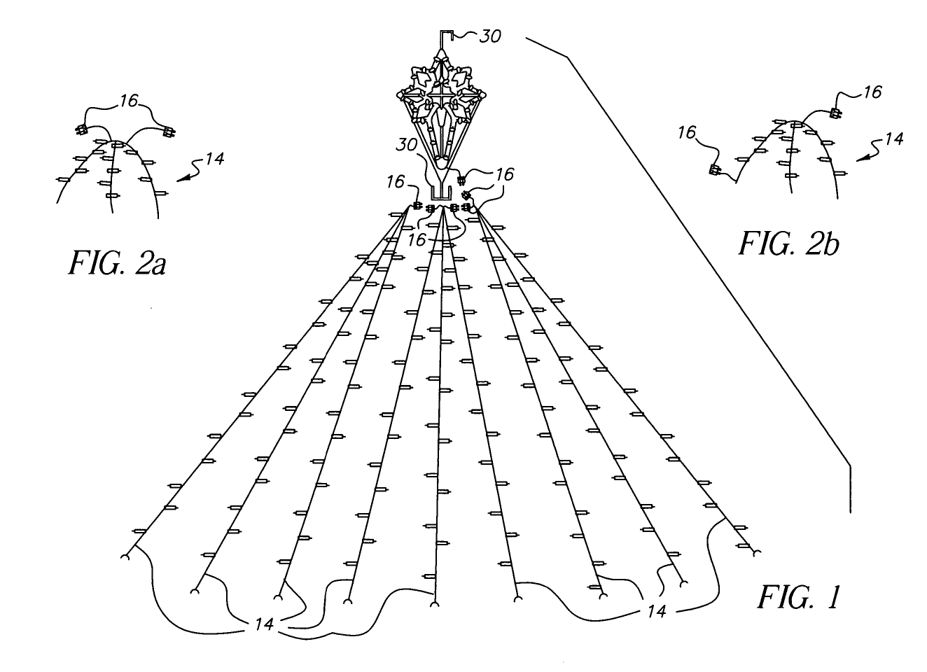

Referring to FIGS. 1-4, a lighting device 10 comprising a head ornament 12 and a plurality of a light strings 14 is provided. The head ornament 12 and the plurality of light strings 14 are electrically coupled together to light up the electric lighting elements such as bulbs thereon. A single electric power (not shown) is used for supplying the lighting device 10 with power. The power may be a residential electric supply socket, a battery, a generator, or any suitable electric power source. Lighting device 10 is physically and electrically divided into a set of units. The units include head ornament 12 and light string 14. The number of light strings 14 may be increased or added. It is noted that light strings 14 are each an electrically and physically independent unit, which can support the unit without the need to wind light string 14 onto any support member. As can be seen, if desired, light string 14 may be wind onto any support member. However, the present invention contemplates using light string 14 without support.

Each unit of lighting device 10, i.e. head ornament 12 and the plurality of light strings 14 have at least one electric connecter 16 coupled to the power source and disposed to receive electric current from the power source. For head ornament 12, a single bi-directional electric connector 16 may be affixed onto any suitable part of the same having a pair of electric leads for electrically connecting to the single bi-directional electric connector 16. In other words, the pair of electrical leads may be formed on head ornament 12.

Light string 14 comprises of any type of known mini lights electrically connected in series with suitable covering or coating for self physical support. The self support is achieve via the physical structure of the light string 14. Alternatively, light string 14 may comprise any other suitable lighting devices such as a rope light. In the present embodiment, each light string 14 has three sub-strings.

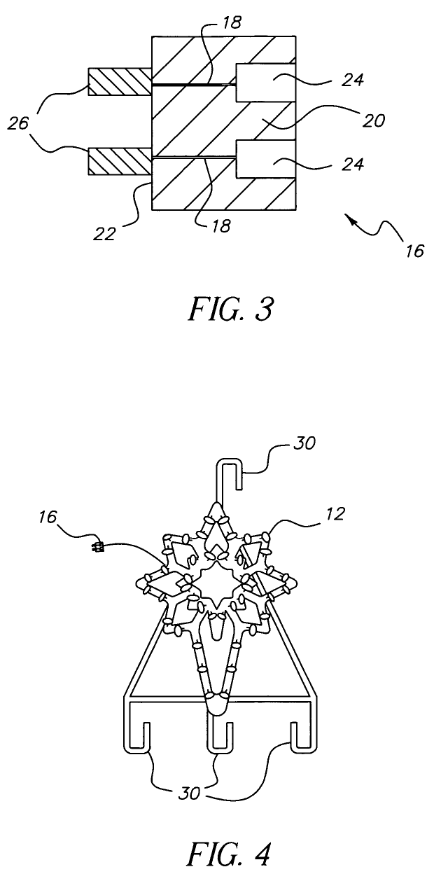

Referring to FIG. 3, the structure of bi-directional electric connector 16 is described. Bi-directional electric connector 16 comprises two electrically independent paths 18 made of suitable, electrically conducting materials. The two paths 18 are formed in parallel and positioned within a solid or semi-solid outer member 20 formed out of an insulating material. Each paths 18 comprises an elongated, electric conducting element 22 embedded within outer member 20. Each conducting element 22 has a first end and a second end. The first end of conducting element 22 is electrically connected to a female receptive member 24, which is formed within outer member 20. The second end of conducting element 22 is electrically connected to a male extending member 26, which extends out of outer member 20. Each pair of female receptive members 24 is adaptive to receive a pair of foreign male extending members 26 from a foreign bi-directional electric connector 16. Similarly, each pair of male extending members 26 is adaptive to engage a pair of foreign female receptive members 24 from a foreign bi-directional electric connector 16. As can be appreciated, the pair of paths 18 may coincide with the two leads of any residential electric wiring.

Bi-directional electric connector 16 may plug directly into a power source socket; or alternatively, bi-directional electric connector 16 may plug into a power source via an extension thereof, such as an extension cord leading from the power source. As can be seen, due to the structure of bi-directional electric connector 16 a single power source having a single socket is sufficient for electrically supplying power to lighting device 10. Each unit of lighting device 10 has at least one bi-directional electric connector 16 as shown in FIG. 3 for electrically connecting to a power source or another bi-directional electric connector 16. Connector 16 is preferably form in as a compact size as possible. For design considerations, the size of the connector has to take into consideration any safety regulations and other design constraints. Furthermore, the structure of connector 16 is adaptive to electrically connect to a power source or an extension thereof by either the female end 24, or the male end 26. In other words, depending upon whether the power source or the extension thereof has a female end or a male end, the male end 26 or female end 24 of connector 16 is respectively used.

As can be seen, head ornament 12 has a single bi-directional electric connector 16, it can be directly connected to the power source and thereby act as the power source. Or alternatively, the single bi-directional electric connector 16 may be connected to other bi-directional electric connectors 16 of the light string 14. Depending upon real situations, the power source may be located at different places in relation to the various bi-directional electric connectors 16. Therefore a bi-directional electric connector 16 which is closest to the power source is the best candidate as the first connecting element to the power source. The rest of the bi-directional electric connectors 16 can be coupled to the power source with the first bi-directional electric connector 16 interposed between them and the power source. Thereby, a reduction or a savings of wire are achieved. A single bi-directional electric connector 16 on each light string 14 is sufficient for supplying electric power thereto. However, due to the dimension of the light string 14, extra bi-directional electric connectors 16 may be formed out of light string 14 for ease of access to a power source.

The present invention contemplates having a plurality of bi-directional electric connectors 16 for unitizing the various units of the lighting device 10. Thereby, lighting device 10 can be easily manipulated by having itself divided into various units for ease of installation. Furthermore, the length or amount of electric wire needed for interconnection is reduced because of the introduction of bi-directional electric connectors 16.

By way of an example, if a user desires to have more than one light string 14 for a light design of her choice, she can just add sufficient numbers of light strings 14 at her choice. This unitized addition of light string 14 facilitates ease in light design, as well as ease in installation.

Head ornament 12 may be affixed onto a solid rack 28 for ease of carrying or installation. Solid rack 28 may have connecting elements 30 for ease of affixing onto an independent structure (not shown). Furthermore, light string 14 may be connected onto the independent structure or any other structure using various known means.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A lighting device comprising:
a plurality of light strings each having at least one bi-directional electric connector electrically connected thereto, with a single bi-directional electric connector connect to a power source, and the rest of the bi-directional electric connectors electrically coupled to the power source having the single bi-directional electric connector interposed therebetween.

2. The lighting device of claim 1 further comprising a head ornament, wherein the head ornament having a bi-directional electric connector.

3. The lighting device of claim 2, wherein the bi-directional electric connector either is the power source, or is coupled to the power source having the single bi-directional electric connector interposed therebetween.

4. The lighting device of claim 1, wherein the bi-directional electric connector comprises two electrically independent electrical paths, each path being disposed to be electrically coupled to one of the leads of an electric power source.

5. The lighting device of claim 1, wherein the bi-directional electric connector comprises a female receptive member, a male extending member, and an electric conducting element interposed between and electrically connecting the female receptive member and the male extending member.

6. A method of producing a lighting device comprising:
providing a plurality of light strings each having at least one bi-directional electric connector electrically connected thereto, with a single bi-directional electric connector connect to a power source, and the rest of the bi-directional electric connectors electrically coupled to the power source having the single bi-directional electric connector interposed therebetween.

7. The method of claim 6 further comprising providing a head ornament, wherein the head ornament having a bi-directional electric connector.

8. The method of claim 7, wherein the bi-directional electric connector either is the power source, or is coupled to the power source having the single bi-directional electric connector interposed therebetween.

9. The method of claim 6, wherein the bi-directional electric connector comprises two electrically independent electrical paths, each path being disposed to be electrically coupled to one of the leads of an electric power source.

10. The method of claim 6, wherein the bi-directional electric connector comprises a female receptive member, a male extending member, and an electric conducting element interposed between and electrically connecting the female receptive member and the male extending member.
